(19) United States
(12) Patent Application Publication
(10) Pub. No.: US 2005/0171818 A1
(43) Pub. Date: Aug. 4, 2005

(54) Patient communication device and method

(76) Inventor: Barbara K. McLaughlin, Wellesley Hills, MA (US)

Correspondence Address: Brown Rudnick Berlack Israels LLP, One Financial Center, Boston, MA, 02111, US

(21) Appl. No.: 11/041,590

(22) Filed: Jan. 24, 2005

Related U.S. Application Data
(60) Provisional application No. 60/538,836, filed on Jan. 23, 2004.

(51) Int. Cl. G06F 17/60

(52) U.S. Cl. 705/3; 705/8

(57) ABSTRACT

A device and method for producing patient appointment reminders for healthcare facilities is provided. The device and method includes receiving one or more sets of information from the healthcare facility including patient data for a patient. The method further includes generating one or more sets of information including appointment information and the like, and combining the sets of information to produce an appointment reminder that is provided to the patient.

### CROSS REFERENCE TO RELATED APPLICATIONS

The present invention claims priority under 35 U.S.C. 119(e) to U.S. Provisional Application No. 60/538,836 filed on Jan. 23, 2004, which is hereby incorporated by reference in its entirety.

### BACKGROUND

1. Technical Field

The present invention relates generally to patient communication devices and methods, and more particularly, to patient appointment reminders.

2. Description of the Related Art

The costs to healthcare institutions for missed patient appointments are very costly and can range into the thousands of dollars dependant upon the particular appointment missed by the patient. Methods of notifying and reminding patients of appointments are known. Hospitals and doctor's offices have used “mailers,” which are folded, sealed forms having limited information therein and which require patients to tear open edges and peel back sections to expose information.

Despite a shift to using a laser cut sheet and standard envelopes, current reminder letters fail to include the information patients require to arrive at the correct destination, at the correct time, and to be properly prepared. Reminders generated using standard scheduling software include little information and are difficult to read and understand, particularly for indigent patients. The result is irritated, anxious patients and increased costs for the hospitals and doctor's offices, and many missed appointments due to lack of understanding. Reminding non-English speaking patients of their appointments is also a problem as translation software typically cannot account for specific dialects, customized preferences or medical terminology.

### SUMMARY

Accordingly, a business method is provided for reminding patients when their appointment is, how to get there, what to bring, how to prepare, what to expect when they arrive for the appointment and the like. The reminder is presented in a single HIPAA compliant, private, sealed document or electronic message that is easy to read and understand. Clerical time, mailings to patient, phone questions and appointment no-shows are greatly reduced. Hospital and doctor's office revenues increase in the millions of dollars, patient satisfaction increases and downtime decreases.

In one embodiment, the method for producing a patient appointment reminder includes receiving a first set of information from a healthcare facility. This first set of information includes patient data for a plurality of patients of the healthcare facility. The method further includes generating second and/or additional sets of information. This second set of information can include appointment information and other information helpful to the patient. The first set of information is combined with the second and/or additional sets of information to produce a plurality of appointment reminders. The appointment reminders containing the sets of information are delivered to each respective patient.

The appointment reminder can include, for example, one or more printed page documents, folded and stuffed in an envelope and mailed to patients, or may be presented electronically via e-mail or the like. The appointment reminder mailing may contain one or more inserts matched to the particular patient and/or medical procedure. Multiple appointment data from different data streams for the same patient can be merged and included in one document. The reminder can be in foreign languages and may be applied to other industries.

### BRIEF DESCRIPTION OF THE DRAWINGS

The foregoing and other features and advantages of the present disclosure will be more fully understood from the following detailed description of the exemplary embodiments, taken in conjunction with the accompanying drawings in which:

FIG. 1 is a flow chart illustrating the method of producing the appointment reminder in accordance with the principles of the present disclosure; and

FIG. 2 is a diagram of the appointment reminder in accordance with the principles of the present disclosure.

### DETAILED DESCRIPTION OF THE EXEMPLARY EMBODIMENTS

The exemplary embodiments of the device and method are disclosed and discussed in terms of patient appointment reminders. It is contemplated that the device and method of the present disclosure may be employed in other contexts such as notifying new college students, convention attendees or other newcomers of appointments, events or other information.

The following discussion includes a description of the device and method, in accordance with the present disclosure. Reference will now be made in detail to the exemplary embodiments of the disclosure, which are illustrated in the accompanying figures.

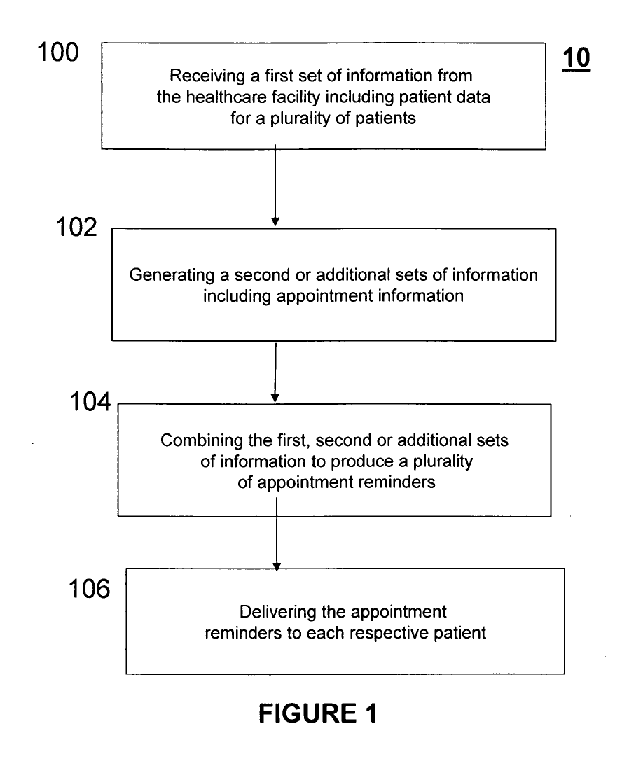

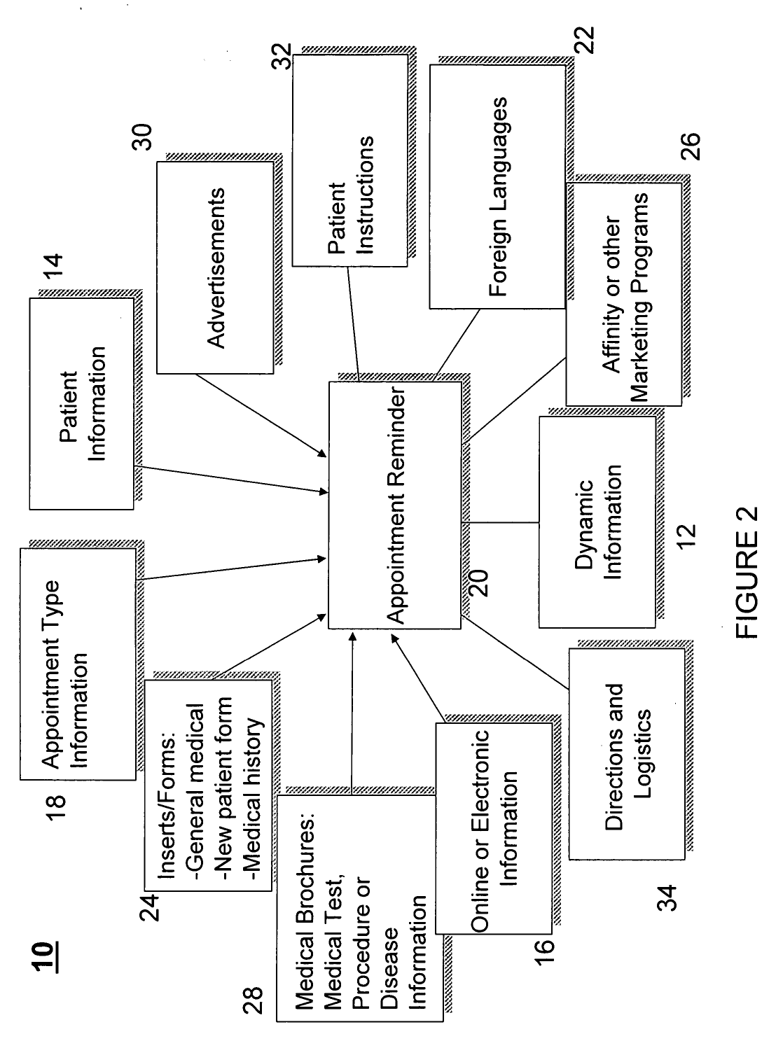

Turning now to the figures, wherein like components are designated by like reference numerals throughout the several views. Referring to FIGS. 1 and 2, there is illustrated an appointment reminder and method of producing such reminder 10. The appointment reminder method 10, as shown in FIG. 1 and described in greater detail below, includes receiving a first set of information from a healthcare facility 100. This first set of information includes patient data for a plurality of patients of the healthcare facility. The method 10 further includes generating a second or additional set of information 102. This second or additional set of information can include appointment information and other information helpful to the patient. The first set of information is combined 104 with the second or additional sets of information to produce a plurality of appointment reminders. The appointment reminders containing the first, second and/or additional sets of information are delivered 106 to each respective patient.

The appointment reminder 20, as shown in FIG. 2, can be printed on paper or presented online, for example, via e-mail or other electronic means. In an illustrative embodiment, the reminder is a one page (two-sided) document which includes static information (that is the same for all patients) or dynamic information (that is variable based on specified parameters). Dynamic information 12 is generally derived from one or more sources and can vary for each appointment reminder and patient, and may include, for example, advertisements 30 tailored to the particular patient or patient appointment, affinity or other marketing programs 26, last minute direction or logistic changes 34, brochures containing medical test, procedure or disease information 28, and the like as will be discussed herein. Much of the information printed on the first side of the reminder is dynamic and includes the patient data or information 14 received from the healthcare facility. This patient information 14 can include, for example, the patient's name, mailing address, medical record number, and patient status, i.e., whether the patient is a new or returning patient.

Appointment information such as the date, day of the week, time, and appointment type is also included and may appear, for example, all in large font. The appointment location such as the campus, building, floor and suite number are also provided. Also included are the provider of care, the provider's phone number (e.g., to change or cancel the appointment) and the best parking available. Preparation needed for the appointment is described and may include medical, physical, directional or other information such as how early to arrive for filling out paperwork or registration. This information is generally not provided by a healthcare facility and is included in the appointment reminder 20 via database insertion (e.g., built by table), added from another file or developed on the fly using a sub-program provided to the facility.

If a patient has more than one appointment at the same medical facility (even if the appointments are on separate campuses or buildings) the files can be merged and the multiple appointment information presented on the same reminder form. In addition, weekly reminder letters can be set up so that appointments for the same week, for the same patient may appear on the same page of the appointment reminder.

Information describing what a patient should bring to the appointment can be printed as static or variable and appear in a designated section or field of the reminder form. This information can be highlighted to indicate the importance for the patient to bring, for example, insurance or worker's compensation forms, authorization from a primary care physician, x-rays, scans, lab results, hospital card, identification, co-payments, balances and the like. This field can also be used to inform patients when and where to arrive for ancillary services or registration.

Special messages may be included and can be static or variable and run for a given time period before changing. These messages can relate to, for example, patient privacy, hospital or federal policies, or other important information such as, for example, that the emergency room has been relocated.

Foreign language information 22 (FIG. 2) may be included in the appointment reminder. This can be, for example, a statement in multiple languages advising the patient that the reminder concerns their medical appointment and they need to have it translated if they do not understand it. The statement may also advise how to get help from the hospital's interpretative services department. Other portions of the reminder such as headings and labels can be provided in foreign languages. It is contemplated to provide the entire reminder (including all static and variable information) in any language.

To provide this foreign language information, a data dump is taken from the hospital database that indicates every possible visit type and medical instructions as well as specific messages. Interpreters fill out the table columns depending on the languages requested. When a language flag appears in a file, the English language file is referenced, but the information in the corresponding foreign language column is printed. The foreign language template is designed and printed so that the appropriate language is printed on the appropriate foreign language template.

Patient medical instructions 32 of all types can be provided within the appointment reminder 10. These patient medical instructions 32 can include, for example, pre or post treatment instructions such as medication indications, what to eat or not eat prior to the appointment and the like. The patient medical instructions 32 are generally a preformed set of instructions that are embodied in tables at the hospital or doctor's offices. Such instructions 32 as with all other parameters of the appointment reminder 10 of the present disclosure are provided in the production of the appointment reminder 10.

Marketing messages 26 and/or other information may be included, for example, a logo identifying the hospital as voted amongst the “Best Hospitals.” Other marketing information may include logos for facilities and companies affiliated with the hospital, information promoting the hospital's research status or religious affiliations, advisements of mergers or split-ups, or other “must read” information of importance to the patient, hospital or caregiver.

The appointment reminder can include information regarding affinity programs 26 beneficial to patients, the hospital or other institutions. These programs may include, for example, privacy programs that protect against identity theft, emergency service programs or a program to help underinsured patients. As another example, a healthcare discount program may be offered to benefit patients and provide revenue for the hospital.

The appointment reminder includes directional and other logistical information 34. This information may include, for example, maps and directions to the facility via public transportation, automobile or walking. Information on how to find the campus and the right building, where to park or what train and bus stops to use is included. Phone numbers for the patient to receive telephone directions, website information to receive on-line directions and information on where to get bus and train schedules, as well as which trains or buses to take, can all be provided. When a patient gets within walking distance of the facility, they can use the maps to navigate to the right building and persons driving can use the maps to find the closest or most convenient parking. When a facility is under construction, the maps can help patients navigate a changing campus or layout. In the case of confidential procedures, for example, cosmetic surgery, the patient can use the maps to find a private entrance.

The maps can be color process maps including multiple colors. These maps can be drawn by hand or computer aided and include information not found in existing hospital maps, which can be outdated or incorrect. The maps of the present disclosure illustrate how to get to the facility as well as how to get to each room or department that the patient is to visit. The maps include up-to-date, accurate graphics developed with input from hospital access personnel. Maps and directional information for even the largest facilities are provided. This is facilitated by the size of the appointment reminder document that can be varied to accommodate the amount of information being provided.

Also contemplated are the printing of variable maps, and inclusion of two dimensional and/or three dimensional drawings of buildings to facilitate identification thereof. Further envisioned are on-demand applications to show patients at check-in precisely how to get to their final destination by way of a dotted line or similar configuration indicating where the patient currently is and exactly where to travel to get to the next destination.

The appointment reminder of the present disclosure can also be presented as an electronic version (e.g., e-reminder), as described later in greater detail. Online or electronic information 16 may include any of the parameters, logistics or information discussed herein. By way of non-limiting example, directional information to patients, where users may scroll through different screens to navigate to the maps and text directions to the facility can be provide via electronic means. The online or electronic information 16 may also be provided in multiple languages and can include all the features and aspects described herein with regard to a paper appointment reminder.

Multiple page reminders can also be provided. Secondary pages may be in duplex format so that variable information can be presented efficiently. Multiple page reminders can be used where the patient has many appointments or the preparation instructions are too great to fit on a single page appointment reminder. Alternatively, a variable, large format insert containing the additional information may be enclosed with the one-page appointment reminder.

Multiple color printing of the appointment reminders is economically provided by preprinting the colors on a lithographic press and using inexpensive black or other one-color lasers for the variable information. This is especially cost effective for smaller hospitals or doctor's offices that run small volumes of reminders each day.

Daily printing and mailing of the reminders (or daily delivery of the e-reminders) is provided regardless of the volume sent by a facility on a given day. For example, where a doctor's office sends a file containing only a handful of appointments for input, printing and mailing of reminders for these appointments is completed on schedule. Conversely, on large volume applications multiple machines are called into service to produce and mail the reminders on schedule.

During production of the appointment reminders according to the present disclosure, templated software programs enables the addition of new hospital or medical facilities with minimized cost and time. Subprograms allow a new facility to add special instructions to each appointment instantly. A database is used to manage the information, and the facility simply inputs the variable information which the database processes. Tables are set up to show variable data as it currently exists so that the facility may change data at any time. The new facility may send information for processing via a Virtual Private Network (VPN), or password protected File Transfer Process (FTP).

The e-reminders are stored on servers. Patients are advised via e-mail that the e-reminders are ready for retrieval at the hospital website via a discrete link. That is, users do not realize they have left the hospital website and are now in the servers. Tracking of who does and who does not pick up their e-reminder is performed. For those e-reminders not picked up, automatic printing and mailing of paper versions guarantees receipt by the patient. User-friendly presentation of the e-reminders is provided by using HTML programming, graphics suited to the small screen, patient-focused sequencing and logical page delineations.

To reduce costs and expedite mailing of the paper reminders, discounts as allowed by the U.S. Post Office (the “post office”) are handled as a pass through item for the facility. Facilities are often able to cost justify the whole process on the basis of these discounts alone, compared with hand mailing documents at full postage rates. Bad addresses from the hospital's system are corrected using postal service software. In addition, the reminder mail is coded in the return address window so that the hospital can identify the reminder without opening it, and redirect or fix it. The hospital's files are updated daily with the post office's most current version of addresses and all mail is pre-bar-coded for the post office. All this ensures fast, cost effective and reliable delivery of the reminders.

The reminder and any related inserts are sent to patients in, for example, a number 10, double window envelope with an inside tint to ensure confidentiality. The double window allows the sender to change return addresses often and/or have multiple return addresses. The number 10 envelope is easy to open, compared to tear-and-peel mailers. If a reply is requested by the hospital, the return container used is a custom window, for example, number 9 envelope, to facilitate processing of the returned piece.

The present disclosure provides for mailing of reminders upon receipt of data from the hospital. However, hospitals send data at least 8 days in advance of appointments to allow for post office delays. This time frame can be shortened to 4-5 days using “drop shipped” service for a premium charge. The hospital can use this expedited service for closer appointments which often involve more expensive medical procedures. In this case, the losses due to missed appointments are lower due to a decrease in missed appointments. It is contemplated to shorten the time frame to 2-3 days using other premium courier services such as Federal Express®. This would result in even less losses due to missed appointments.

The file sent by the hospital includes a designation as to whether a patient is new or a returning patient. If it is determined that the patient is new, a medical history form 24 is enclosed with the appointment reminder sent to the patient. This allows the patient to complete the form before they get to their appointment, which reduces time and aggravation for the patient and the doctor's office. The doctor can see more patients in a day since there is not as much office backlog. Patients can take their time filling out the medical history form and give more thoughtful answers to questions contained therein. Demographic data from the hospital file can be automatically filled in on the form to further reduce patient time spent completing the forms. Like the appointment reminder, the medical history form can be sized to hold a great deal of information or customized for a hospital's needs.

The healthcare facility appointment type information 18 can also include specialty-specific questions, since the appointment type is known for each patient. For example, where a patient's appointment is with an Ear, Nose and Throat (ENT) specialist, the medical history form can include a questionnaire relating to nasal/sinus problems or a questionnaire regarding dizziness issues. In this way, what may have originally been a ten page questionnaire can be condensed into a one page form without compromising the questionnaire quality. The patient can complete these questionnaires before arriving at the doctor's office. As with the appointment reminder, the medical history form and questionnaires can be presented on-line and made available in a printable form for patients to print locally. This reduces in-office time for patients spent completing these forms.

Brochures 28 relating, for example, to a patient's disease or medical test and procedures can be included along with the appointment reminders. This eliminates the need to mail the brochure separately, reduces patient anxiety and provides answers to their questions. Persons receiving appointment reminders are a captive audience (i.e., one to one marketing) and facilities can use this mailing to communicate other important information to these individuals. For example, patient surveys, marketing inserts, advisements of hospital changes or free services can be included with the reminders. Using the appointment reminder to send information to patients is a cost effective way to communicate with them in a non-offensive manner.

The appointment reminder can be produced cooperatively or on a “shared space” basis. For example, an advertisement 30 or offer for a patient insurance plan can be included on the appointment reminder. The insurance plan provider supports processing costs in exchange for this presentation. The insurance advertisement can be customized using the data feed from the hospital to identify characteristics that may cause the appointment reminder and/or advertisement to vary.

In production, appointment reminders for smaller offsite healthcare facilities can be, for example, of standard 8.5″×11″ size since there is typically only one appointment on each reminder. Alternatively, it is contemplated to create a standard preprinted form for all the clinics associated with a particular medical group or organization and print each map from a specified predeveloped graphic by address. This allows flexibility for change of provider address and is less costly than using multiple preprinted templates.

Also contemplated is a print-on-demand appointment reminder. This involves supplying the preprinted documents and software to facilities so they can print these appointment reminders on demand at each using site. This is important for same or next day appointments or for places that set up appointments for several months at one time (i.e., physical therapy or psychiatry offices).

Flipping of the data (from the top stub to the bottom stub) allows automated processing of the appointment reminders so that they become machineable after printing. Using automatic inserters guarantees fast turn around and fewer delays and eliminates the need for hand stuffing the oversize reminders into the envelopes. Use of a production barcode allows the inserting machine to read the reminders and identify the beginning and end of each patient's information. This ensures double stuffing does not occur. Counters facilitate a one-to-one match on all mailings, and thus for every file received an envelope goes in the mail. This facilitates 100% data-to-mail integrity. If any of the counts are off by even one, the mail is held till the missing piece is found.

The barcode also facilitates finding any piece of mail among the thousands of pieces to be mailed each day. This allows pulling any envelope out of the mail stream up to the moment the post office has possession of the mail. For example, if Mr. Jones is scheduled for an appointment next Wednesday but dies today, that appointment reminder is pulled and not mailed to his home. This last-minute pull function is a useful feature that hospitals embrace.

The present disclosure can also provide an “exception” service for a facility. For example, a facility may specify a rule that requires “never send mail to our CEO.” This rule is then written into the software to ensure that this never happens. Healthcare institutions typically have many such rules, and the exception service saves time and costs.

It is contemplated to enclose pressure sensitive labels with the appointment reminders for patients to stick on calendars. These labels can be generic or customized and include the date, time and place of each appointment. It is also envisioned to use document imaging for capturing data without hand keying. This improves data quality, data access time and decreases costs.

A patient identification barcode may be included on the reminder to facilitate patient check-in wherein a scanner scans the barcode to identify the patient instantly, record their arrival, and otherwise speed the check-in process. The barcode also facilitates processing of undeliverable mail by automatically identifying the patient without having to open the returned envelope. It is further envisioned that the barcode can be used to automatically generate requests for lab or ancillary tests and other care instructions to the providers.

The present disclosure also provides for after care letters. Since the data for patient appointments is known, the same data can be used to inform patients after their appointment of the results of any exams, consults, test, or lab results in a timely, easy to use manner. A sub program automatically extracts the patient information and appointment types and presents them to the providing physician. Using an internet turnkey program the doctor can then select from a drop down menu to fill in the blanks of results information for the patient, or use a free text section to write custom information. When the doctor completes the after care letter, the data is automatically transmitted for formatting, printing and mailing to the patient in a timely manner. An automatic email can also be sent to patients that prefer this, so they are quickly advised of the results of their healthcare appointment. This is done in a secure, password protected manner, and the email can be picked up through a link to the servers. Patients after they are seen can find out the results of their tests, etc. without waiting weeks or longer. A referring physician letter can also be automatically generated and sent to the referring physician informing them of the patients' results after they have been seen by specialists on a referral basis.

The invention of the present disclosure may be embodied in other specific forms without departing from the spirit or essential characteristics thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A method for reminding patients of their medical appointments at a healthcare facility, comprising the steps of:
receiving a first set of information from the healthcare facility including patient data for a plurality of patients of the healthcare facility;
generating a second set of information including appointment information;
combining the first and second sets of information to produce a plurality of appointment reminders, wherein the first and second sets of information include at least one of static information that is similar for all patients and at least one of dynamic information that is variable based on predetermined parameters; and
delivering each of the appointment reminders to each respective patient.

2. The method of claim 1 wherein the patient data includes a name, mailing address, medical record number for each patient and indicates whether the patient is a new patient or a returning patient.

3. The method of claim 1 wherein the first set of information is received from the healthcare facility over a virtual private network to provide security.

4. The method of claim 1 wherein the second set of information includes foreign language information.

5. The method of claim 1 wherein the second set of information includes maps and other directional information for directing the patient to their appointment, the maps including multiple colors.

6. The method of claim 1 wherein the appointment reminder is one of a paper version for mailing to the patient or an electronic version for electronic delivery to the patient.

7. The method of claim 6 wherein producing the electronic version of the appointment reminder includes reformatting the patient data received from the healthcare facility for online presentation.

8. The method of claim 6 wherein during the delivery step, the electronic version of the appointment reminder is available for pick up by the patient at a website of the healthcare facility.

9. The method of claim 2 wherein when the patient data indicates that the patient is a new patient, a medical information form for the patient to complete in advance of their appointment is enclosed along with the appointment reminder.

10. The method of claim 1 wherein a brochure relating to a patient's condition or appointment procedure is included along with the appointment reminder.

11. The method of claim 1 wherein the appointment reminder includes marketing information or other information promoting affinity programs beneficial to patients, the healthcare facility or other institutions.

12. The method of claim 1 wherein a patient identification barcode is included on the appointment reminder to facilitate automatic identification of the patient at check-in at the healthcare facility.

13. An appointment reminder for use by a healthcare facility comprising:
patient data information;
patient medical instructions;
patient medical history questioner; and
medical brochures.

14. A patient appointment reminder for reminding patients of their medical appointments at a healthcare facility, the patient appointment reminder comprising:
patient data information including patient's name and mailing address;
patient medical instructions related to the patient's medical appointment; and any one of marketing information or advertisements.
